(19) United States
(12) Patent Application Publication
(10) Pub. No.: US 2006/0080205 A1
(43) Pub. Date: Apr. 13, 2006

(54) Method of borrowing, investing and managing and investment fund

(76) Inventor: Brian Starr, Lubbock, TX (US)

Correspondence Address: INTELLECTUAL PROPERTY/PORTFOLIO STRATEGIES, PLLC, 5440 31ST STREET, N.W., WASHINGTON, DC, 20015, US

(21) Appl. No.: 11/227,750

(22) Filed: Sep. 15, 2005

Related U.S. Application Data
(60) Provisional application No. 60/610,946, filed on Sep. 20, 2004.

(51) Int. Cl. G06Q 40/00

(52) U.S. Cl. 705/35

(57) ABSTRACT

Investors purchase shares of a closed-end investment fund of tuition package repurchase agreements with a university. On a specified date, the university receives cash based on their current tuition rates times the number of repurchase agreements into which they have entered. As the contractual repurchase agreements reach their specified maturity dates, the university is required to repay the fund in an amount corresponding to tuition rates prevailing at the stated maturity date. Monies collected from universities would be used to repay investors commensurate with the shares held.

### REFERENCE TO EARLIER APPLICATION

This Application claims priority to U.S. Provisional Patent Application Ser. No. 60/610,946, filed Sep. 20, 2004.

### BACKGROUND OF THE INVENTION BACKGROUND OF THE INVENTION

Currently, each state has adopted its own college savings plan commonly referred to as “529 Prepaid Tuition Plans” or “529 Savings Plans.” Generally, prepaid plans allow for vouchers that guarantee tuition credits toward future tuition, while savings plans invest funds in equity markets with proceeds being used to cover educational expenses.

Both types of plans offer tax advantages if funds are used to cover qualified educational expenses at specified institutions. However, because of their tax benefits, the IRS has imposed contribution limits on 529 plans and rulings on future tax status of these funds have not been determined.

Additionally, investments within 529 Savings Plans carry a general risk that rising tuition costs will outpace their investment returns given the inherent risks within equity markets. For universities, there is no short-term benefit, given that funds within prepaid plans are invested by the state or a private investment firm, not the university, and few long-term benefits given that vouchers most likely will be somewhat less than future tuition once funds are received.

Many states have canceled further enrollment into 529 Prepaid plans, opting instead to move toward 529 Savings Plans. Nevertheless, college savings plans have come under criticism in recent years due to upfront enrollment fees, residency requirements, complicated investment options, tax issues, withdrawal penalties and annual fees and expenses.

An alternative to the 529 College Savings & Prepaid plans is a Coverdell IRA, also referred to as Coverdell Educational Savings Account or ESA. Like 529 plans, Coverdells are restricted to annual contribution limits, but offer similar tax benefits as 529 plans. The key advantages that Coverdells have over other plans is that since individual account owners manage the investment assets, the use of proceeds for a broader array of qualified educational expenses is permitted.

The present method eliminates many of the issues described above by creating for universities a flexible financing alternative, and crafting for investors an ability to hedge against escalating tuition and educational expenses. Universities benefit by being able to invest in themselves, which can attract quality faculty, and increase enrollment, endowments and research. Individual investors benefit by tying investment returns directly to changes in tuition rates, and thus receive the peace of mind that funds put aside for higher education will be available and adequate when needed. Investors also are not tied to the complex terms and conditions typical to state-sponsored college savings vehicles.

### SUMMARY OF THE INVENTION

The present method, herein referred to as Tuition Repurchase Investment Program (TRIP), is an agreement between investors and a diversified pool of domestic universities. The investors purchase pooled tuition packages at current rates from participating universities, and each university agrees to repurchase its tuition packages in future years at its tuition rate prevailing at the time of the repurchase.

In operation, a single closed-end investment fund or unit investment trust is established for each successive year between five and 20. Each fund may be identified by the year in which the tuition repurchase obligations mature. For example, the fund holding tuition repurchase obligations maturing in 2010 could be known as TRIP-2010.

Universities from around the country are invited to enter into tuition repurchase agreements with one or more of the funds. Investors then are solicited to invest in one or more of the funds with shares issued to each investor directly proportionally to the investor's percentage of the total investment.

At the inception date for the TRIP obligations, each university would receive cash equaling the number of tuition packages it has agreed to repurchase, multiplied by the current price of such a tuition package. At the spe d maturity date of the obligations, each participating university would repay to the fund a cash amount equal to the number of tuition packages it has agreed to repurchase, multiplied by the prevailing price of its tuition packages. The fund will use the cash proceeds to repurchase shares from its investors. Each fund terminates after the tuition obligations have been collected from each participating university, and the cash is distributed proportionally to the investors.

Ideally, to limit default risks and the risk of underperformance, only accredited universities should be invited to participate. In addition, each university should have a 25-year operating history with demonstrated annual tuition increases positively and significantly correlated to the national averages. Universities also would be constrained to raising no more than 15 percent of their annual tuition revenue using any one TRIP maturity year. Additionally, no one school would be able to represent more than 20 percent of total obligations for any one fund.

For Investors, TRIP provides an opportunity to earn a rate of return tied to the general rate of tuition increases thereby offering an almost perfect hedge against rising future tuition costs. Individual investors wishing to save for future college spending will not bear specific risks associated with the equity and corporate bond markets. Because the repayment of investment dollars is tied to a pool of university tuition repurchase agreements, the rate of return will mirror the average rate of tuition inflation for the pool.

If TRIP shares are purchased within a tax-qualified arrangement, individual investors may invest in the TRIP product up to a specified maximum limit, which is currently imposed under 529 Plans, Coverdells or other college savings plan arrangements. Alternatively, if TRIP shares are purchased outside of a tax-qualified arrangement, no such limit would exist on the amount of lump-sum or annual purchases desired.

As a method of investment financing for universities, TRIP allows an alternative source of funding that offers unique flexibility in structure and repayment terms as compared to customary funding sources. Revenue bonds and other financing sources available to universities usually are tied to specific capital projects and almost always require periodic interest and/or principle payments to begin quickly. Furthermore, significant fees and expenses, including origination fees, commitment fees, capitalized interest, legal fees, and underwriting fees, often exist when offering revenue bonds or securing debt financing. TRIP financing allows universities to raise capital for projects that may not be feasible under traditional financing terms. Additionally, TRIP allows universities significant savings in fees and expenses.

TRIP allows institutions to raise funds for projects that may not generate immediate returns on capital and/or for which the return may not be tied directly to tangible monetary returns. For example, a university may wish to build a new student center and fund a program to beautify its campus, including the construction of a fountain at its front entrance, These efforts would help the university enhance its image and attract students, but the benefits attained through increased enrollment may take time to materialize and may not be easily quantifiable.

Universities also could benefit from structuring financing for projects in a consistent manner not influenced by the economic impacts of credit markets. For example, a university lacking student housing options may wish to embark on a five-year campaign to construct six dormitories costing an estimated $15,000M. They would be able to plan for the construction in three phases representing repurchase agreements of $5,000M each for the next three years, due in 20 years, and could plan each phase of the project without concern for whether general interest rates may raise sharply or credit conditions in the economy may tighten.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIGS. 1 and 2 are schematic views of an embodiment of a method configured according to principles of the invention.

### DETAILED DESCRIPTION OF THE PREFERRED EMBODIMENTS

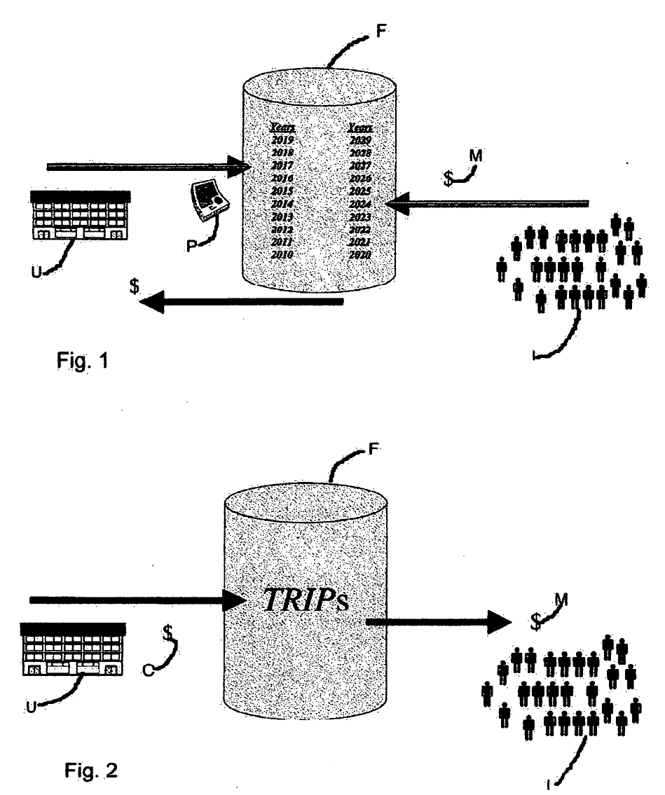

Referring to FIG. 1, TRIP allows for tuition package P repurchase agreements to be entered into between universities-U wishing to raise capital and a closed-end investment fund F, or Unit Investment Trust (UIT), holding investment funds M from individual investors I in exchange for shares S in fund F.

The repurchase agreements are developed for each successive maturity year between five and 20 years, e.g. 2010-2029. Accredited universities would enter into various repurchase agreements for any or all of the successive maturity years offered by the given inception date after which time no further repurchase obligations would be accepted for that given year.

Shares of each closed-end investment fund would be available for investors to purchase. In exchange for invested monies M, investors would receive units or shares S in one or more of funds F holding the repurchase agreements. On a specified date, each participating university would receive cash based on their own current tuition rates times the number of repurchase agreement units into which they have entered. Each university would be able to use this cash for capital projects and expenditures as they see fit.

Referring to FIG. 2, as the contractual repurchase agreements between the investment management fund F and the university U reach their specified maturity dates, each university U would be required to repay the closed-end investment fund. The amount of money C received from each participating university would correspond to each universities' prevailing tuition rates at the stated maturity date. Monies collected from universities would be used to repay investors commensurate with the shares held. Each closed-end investment fund terminates as the universities repay their stated contractual agreement and funds are returned to investors. The investors may use the returned funds for educational expenses or any other expense as they see fit.

Each TRIP investment trust would be listed as a registered security with the Securities and Exchange Commission. If the fund is crafted as a closed-end investment fund, the shares could be traded on the secondary market where price is determined efficiently through bid-and-ask prices of buyers and sellers; no determination of price based on assumptions or other valuations would be needed. If the fund is crafted as a unit investment trust, shares would be redeemed by the trust itself, and only at maturity.

TRIP may charge a one-time management fee at the inception of each fund. The management fee may be approximately 1 percent of assets for the five year fund. Each fund of longer duration may be charged an additional 0.10 percent of assets for each year in excess of five years. For example, a 25-year TRIP fund would be charged a one-time management fee of three percent. The fee offsets the cost of fund setup and maintenance, record keeping, customer service and other custodial duties through its duration. This fee compares quite favorably to the fees an investor would pay over a five to 30-year history with an open-end mutual fund or similar investment. There also is a possibility that a portion of this fee could be imposed on participating universities, which would lower the fees imposed on investors. For universities, a nominal fee still would compare quite favorably to fees typically charged to create revenue bonds or other sources of financing, which may incur commitment fees, origination fees, underwriting fees, capitalized interest and discounting.

### EXAMPLE

TRIP Financial Management invites universities wishing to raise capital to participate in a series of Tuition Repurchase Obligations. U.S. University evaluates TRIPs as a means to raise $40,000,000 to construct a series of student housing facilities. U.S. University enters into TRIP2020 and TRIP2021 with repurchase obligations of $20,000,000 in for each of these two maturities. TRIP Financial Management facilitates similar repurchase agreements with 50 other universities for maturities ranging from 2010 to 2029. The aggregate of all obligations totals $2,000,000M.

TRIP Financial Management markets the TRIP notes to investors for purchase. Mary Smith is one such investor. She wants to set aside enough money for her granddaughter, Katrina, to attend a private university. Katrina is three years old, and the current cost of four years worth of tuition and fees at private universities is approximately $80,000. Mary invests $80,000 in TRIP2019.

If the national tuition inflation rate for the next 15 years turns out to be 9 percent per year, the TRIP2019, being made up of a diverse group of universities, replicates that rate of return with its tuition repurchase investments. The TRIP2019 fund purchased for Katrina would be worth $285,570.

This example assumes a 2% up front management fee that is assessed on the original $80,000. This example does not assume any capital gains or other tax related expense.

TRIP funds may be suitable investments in qualified or non-qualified asset categories. Accordingly, many investors may seek tax shelter by purchasing TRIP shares withing 529 plans, trusts or other tax sheltered accounts. As each school with contractual obligations, such as U.S. University, repays TRIP2019 at current tuition rates, funds are distributed back to investors and TRIP2019 is terminated. In this example, the amounts distributed back to Katrina could be used to finance her education at any school. Should she decide not to attend college or selects a less expensive university, the remaining cash could be used at, and according to, the discretion of the account owner.

One theoretical construction for TRIP is that of a Unit Investment Trust (UIT). A UIT is a trust that holds a fixed portfolio of securities that are offered in “unit” increments. Investors receive a share of the trust's earned incone, if any, and their share of the holdings at the trust's maturity. Unlike a mutual fund, a UIT is created for a specific length of time and is a fixed portfolio, meaning that the UIT's securities will not be sold or new ones bought, except in certain limited situations.

A UIT typically issues shares redeemable only at maturity. Unlike a mutual fund, that trust does not typically redeem investor shares prior to maturity.

A UIT typically will make a one-time “public offering” of only a specific, fixed number of units, like closed-end funds.

A UIT will have a specified termination date, which is established when the UIT is created. Some UlTs may terminate more than fifty years after they are created. In the case of a UIT investing in bonds, for example, the termination date may be determined by the maturity date of the bond investments. When a UIT terminates, any remaining investment portfolio securities are sold and the proceeds are paid to the investors.

A UIT does not actively trade its investment portfolio. That is, a UIT buys a relatively fixed portfolio of securities, for example, five, ten, or twenty specific stocks or bonds, and holds them with little or no change for the life of the UIT. Because the investment portfolio of a UIT generally is fixed, investors generally know what they are investing in for the duration of their investment. Investors will find the portfolio securities held by the UIT listed in its prospectus.

The invention is not limited to the particular embodiments described and depicted herein, rather only to the following claims.

I claim:

1. Method of borrowing comprising:
assuming an obligation for a tuition package; and
receiving financial assets therefor.

2. Method of claim 1, wherein:
said assuming or receiving occurs on a first date; and
a value of the financial assets corresponds to a value of the tuition package prevailing on the first date.

3. Method of claim 1, further comprising honoring the obligation on a second date.

4. Method of claim 3, wherein the obligation has a value that corresponds to a value of the tuition package prevailing on the second date.

5. Method of claim 3, wherein said honoring comprises providing financial assets, educational services or a combination thereof.

6. Method of investing comprising:
providing financial assets; and
receiving a share of a fund therefor;
wherein:
the fund comprises at least one obligation for a tuition package; and
said providing or receiving occurs on a first date.

7. Method of claim 6, wherein a value of the fund corresponds to a value of the at least one obligation for a tuition package prevailing on the first date.

8. Method of claim 6, further comprising redeeming the share on a second date.

9. Method of claim 8, wherein the fund has a value that corresponds to a value of the at least one obligation for a tuition package prevailing on the second date.

10. Method of claim 8, wherein said redeeming comprises receiving financial assets, educational services or a combination thereof.

11. Method of operating an investment fund comprising:
receiving an obligation for a tuition package; and
providing financial assets therefor;
wherein said receiving or providing occurs on a first date.

12. Method of claim 11, wherein a value of the financial assets corresponds to a value of the tuition package prevailing on the first date.

13. Method of claim 11, further comprising redeeming the obligation on a second date.

14. Method of claim 13, wherein the obligation has a value that corresponds to a value of the tuition package prevailing on the second date.

15. Method of claim 13, wherein said redeeming comprises receiving financial assets, educational services or a combination thereof.

16. Method of operating an investment fund comprising:
receiving financial assets; and
providing a share of a fund therefor;
wherein:
said receiving or providing occurs on a first date; and
the fund comprises at least one obligation for a tuition package

17. Method of claim 16, wherein a value of the share corresponds to a value of the at least one obligation for a tuition package prevailing on the first date.

18. Method of claim 16, further comprising redeeming the share on a second date.

19. Method of claim 18, wherein the fund has a value that corresponds to a value of the at least one obligation for a tuition package prevailing on the second date.

20. Method of claim 18, wherein said redeeming comprises providing financial assets, educational services or a combination thereof.
